(19) United States
(12) Patent Application Publication
(10) Pub. No.: US 2026/0288486 A1
(43) Pub. Date: Sep. 24, 2026

(54) SYSTEMS AND METHODS FOR DYNAMIC CONFIGURATION MANAGEMENT

(71) Applicant: JPMORGAN CHASE BANK, N.A., New York, NY (US)

(72) Inventors: Varun MONGA, Bengaluru (IN); Nada ZIAB, Wilmington, DE (US); Jason Jiseok KIM, Woodstock, MD (US); Maxwell JANNEY, Wilmington, DE (US)

(21) Appl. No.: 19/203,949

(22) Filed: May 9, 2025

(30) Foreign Application Priority Data
Mar. 19, 2025 (IN) 202511024500

(51) Int. Cl. G06F 9/445; G06F 9/54

(52) U.S. Cl. CPC G06F 9/44521; G06F 9/541

(57) ABSTRACT

In some embodiments, the techniques described herein relate to a method including: receiving, through an application configuration manager executed by one or more processors, a property update request for a property; determining, by the adaptive configuration manager, authentication and authorization of the property update request; determining, by the adaptive configuration manager, if a registered API associated with the property is active; determining, by the adaptive configuration manager through a call to an adaptive case management application, if the property associated with the property update is registered; updating, by the adaptive configuration manager, a property value of the property in a property database operatively connected to the adaptive configuration manager; and refreshing, by the adaptive configuration manager, the property in the client application.

### BACKGROUND

### 1. Field of The Invention

Aspects generally relate to systems and methods for dynamic configuration management.

### 2. Description of the Related Art

In dynamic environments, modern enterprise applications require frequent configuration changes to maintain optimal performance, uptime, and stability. However, managing configurations introduces several operational challenges including restart dependency where changing application properties often requires restarting the application, leading to downtime or disruption of services. Managing configurations also suffers from static configurations where applications rely on pre-defined configurations that cannot adapt dynamically to changes in real-time operational conditions. Managing configurations also has challenges from manual intervention where responding to alerts (e.g., from monitoring tools) to adjust application behavior is manual and prone to delays, increasing the risk of service degradation. Managing configurations also lack automated control, waiting for human intervention without a mechanism to automatically respond to specific events or thresholds, businesses face challenges in maintaining system stability and optimal performance. Current configuration systems are inflexible in response because the current systems cannot self-correct or adapt when thresholds are breached, increasing maintenance overhead.

To address these challenges, a tool is needed that has an ability to adapt configurations dynamically across any onboarded application and respond to environmental changes automatically with minimal intervention.

### SUMMARY

Exemplary embodiments provide systems and methods for generating a merchant trust score. According to one embodiment, a method may include: receiving, through an application configuration manager executed by one or more processors, a property update request for a property; determining, by the adaptive configuration manager, authentication and authorization of the property update request; determining, by the adaptive configuration manager, if a registered application programming interface (“API”) associated with the property is active; determining, by the adaptive configuration manager through a call to an adaptive case management application operatively connected to a registration database, if the property associated with the property update is registered; updating, by the adaptive configuration manager, a property value of the property in a property database operatively connected to the adaptive configuration manager; and refreshing, by the adaptive configuration manager, the property in the client application.

In some embodiments, the property update request may be initiated by a server providing an update to a type of application that includes the client application. In some embodiments, the property update request may be initiated by a server monitoring application determining that the property value of the client application exceeds a threshold. In some embodiments, the determination that a registered API is active may be determined by a state change in the registered API captured by the adaptive configuration manager. In some embodiments, the determination that a registered API is active may be determined by a periodic check performed by the adaptive configuration manager invoking the API's endpoint.

In some embodiments, the property value may be a feature flag that the adaptive configuration manager updates without restarting the client application. In some embodiments, the property value may be a API rate limit adjusted by the adaptive configuration manager in real-time based on traffic patterns recorded by the client application that the adaptive configuration manager receives by determining a state of the client application. In some embodiments, the adaptive configuration manager may change a threshold of the client application to reduce allowed requests per second. In some embodiments, the property value be a configuration setting adjusted by the adaptive configuration manager for different user segments without code changes by switching between feature versions of the client application.

In some embodiments, the property value may be an increase of a connection timeout that the adaptive configuration manager changes without a restart of the client application. In some embodiments, the property value may be an increase of a logging verbosity for debugging issues in production that the adaptive configuration manager changes without restarting the application. In some embodiments, the property value may be a change of a third-party API key by the adaptive configuration manager if an external service changes the third-party API key or endpoint. In some embodiments, the property value may be a business rule, wherein the adaptive configuration manager updates the property based on a change of the property value associated with the business rule without modifying code or restarting services.

In some embodiments, refreshing may occur by the adaptive configuration storing one or more or each property in a database and exposing the property via the adaptive configuration manager's API. In some embodiments, updating may be accomplished by a custom-built library being periodically invoked by the adaptive configuration manager's API, wherein the adaptive configuration manager fetches an updated property from updating a current environment with the updated property.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for dynamic configuration management, in accordance with embodiments.

FIG. 2 is a method for dynamic configuration management, in accordance with embodiments.

FIG. 3 is a block diagram of a computing device for implementing certain aspects of the present disclosure.

### DETAILED DESCRIPTION

Aspects generally relate to systems and methods for dynamic configuration management.

Disclosed are systems and methods including a dynamic property configurator (DPC) that allows applications (Photon, Spring Boot, etc.) to dynamically change configuration properties at runtime without requiring a restart. The solution is generic, making it easy for any application to onboard by pulling in a thin client library, reducing the integration effort. Further, a smart rule engine (SRE) is disclosed herein that integrates with monitoring tools like Splunk to detect alerts or breaches of predefined thresholds (e.g., violation of a rule). The SRE further may automatically adjust properties in real-time to modify the application's behavior, ensuring continuous optimization and stability.

When current systems are used to update a feature flag or configuration property for a running application, the process involves several complex steps including modifying the target configuration property, disabling GLBs (“global load balancing”) to stop traffic to a pool/cluster, restart the application, wait for each application instance to start, re-enable GLBs to allow traffic back to the pool/cluster, repeat disabling, restarting, waiting, and re-enabling for each pool/cluster. A GLB system may be a networking solution that distributes traffic across application instances deployed across GAP pools, ensuring optimal performance, high availability, and redundancy by directing users to healthy instances based on load, latency, and health status. A typical scenario for a high-volume application programming interface (“API”): running on 10 pools, has 4 instances per pool, and has 6 unique GLBs. Current systems must thus manage and wait for 40 application instances and needing to disable/enable traffic 60 times. Repeating these steps multiple times is redundant, time consuming, and error prone.

Disclosed systems and methods resolves these issues in an efficient manner by, through the Adaptive Configuration Manager (ACM): conducting real-time property updates, modifying feature flags and configuration properties at runtime without restarting the application or disabling GLB systems, resulting in little or no disruption to traffic or downtime. The ACM further integrates monitoring tools like Splunk to dynamically adjust properties when alerts or thresholds are triggered, automatically adapts the application based on real-time conditions to maintain optimal performance as a type of self-healing behavior, exhibits increased operational efficiency because no manual intervention needed to disable GLB systems or restart instances, and reduces errors by automating property updates through pre-configured rules.

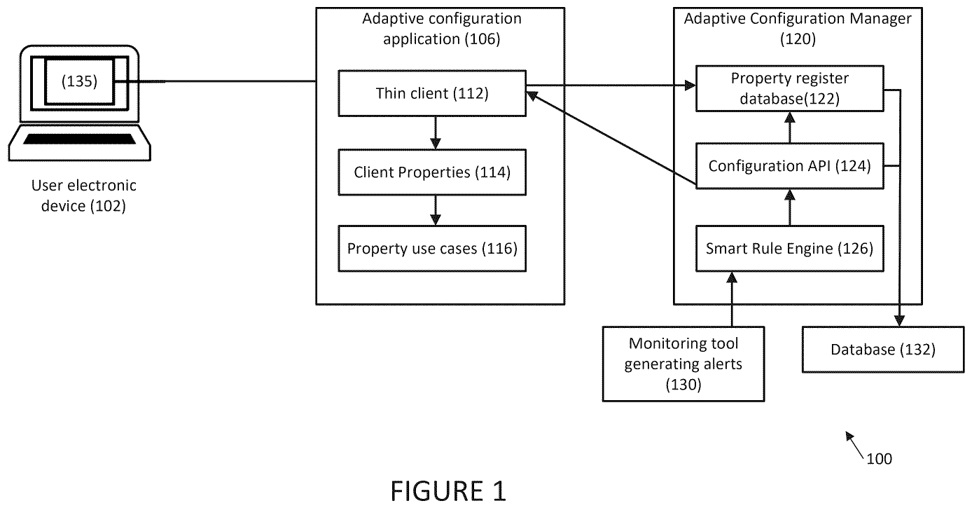

FIG. 1 is a block diagram of a system for dynamic configuration management, in accordance with embodiments.

System 100 includes a user electronic device 102 executing an adaptive configuration application 106 available through a user interface 135, a adaptive configuration manager 106. Adaptive configuration application 106 and adaptive configuration manager 106 may be executed on a network or computer including a processor executing one or more software modules and a memory for storing data accessible by the one or more software modules and instructions to execute the one or more software modules. Adaptive configuration application 106 may include one or more software modules including one or more of thin client 112, client properties 114, and property use cases 116. Adaptive configuration manager 120 may include one or more software modules including one or more of property register database 122, configuration application programming interface (“API”), and smart rule engine (“SRE”). Adaptive configuration manager 120 may be in communication with one or more database 132 and/or monitoring tool 130 through APIs and/or through messages sent over a network connection.

Adaptive configuration manager 120 may be a set of software components working together and executed by a server and/or a computer. The server may be part of an institution backend. The server may be part of a cloud-based server. In some embodiments, the adaptive configuration manager 120 may reference one or more databases that are cloud-based or part of a network or computer to store information including executable instructions of adaptive configuration manager 120 and/or one or more software components.

In accordance with some embodiments, user electronic device 102 may be a user electronic device such as a personal communication device (e.g., tablet, phone), computer workstation, laptop, or other electronic processing device in operative communication with adaptive configuration application 106 and adaptive configuration manager 106. User electronic device 102 may be configured to interact with adaptive configuration application 106 through user interface 135. For instance, user device 102 may include a client application that allows a user of user electronic device 102 to interact with adaptive configuration application 106. User interface 135 may include one or more graphical user interfaces to receive inputs and/or display information to the user. User interface 135 and/or adaptive configuration application 106 may comprise one or more instructions executed by one or more processors of user electronic device 102. Adaptive configuration application 106 may be a software production application provided by a service organization. In some embodiments, adaptive configuration application 106 may be a configuration management application or system.

In some embodiments, adaptive configuration application 106 may initiate an application programming interface (“API”) request (e.g., call) to communicate with adaptive configuration manager 120 to generate and manage configurations for target applications including applications currently executing on one or more processors. In some embodiments, adaptive configuration application 106 may respond to an API call with updates to target application such as to any client properties as discussed further herein. The adaptive configuration application 106 may check one or more target applications and/or configuration updates for periodic updates. The adaptive configuration application 106 may pull updates to one or more configurations or model configurations or may check for configuration updates based on an event (e.g., such as based on a user instruction or an updated model configuration (e.g., including to one or more properties or use cases)

A client application may be a photon/spring boot application. Adaptive configuration application 106 may be a client application. Adaptive configuration application 106 may embed a thin ACM client 112 to pull or update configuration properties at runtime.

ACM 120 may include a property store that acts as a centralized repository for application properties. Smart Rule Engine (SRE) 126 may monitor alerts from external tools such as monitoring tool 130 and automatically update property values without downtime.

Configuration API 124 may provide an interface for both applications such as adaptive configuration application 106 and one or administrators to query or update configuration properties dynamically. In some embodiments, a notification manager software component within ACM may be responsible for sending notifications whenever a property change is performed dynamically, ensuring relevant client applications are promptly informed. SRE 126 may, after receiving an alert from monitoring tool 130, apply property overrides.

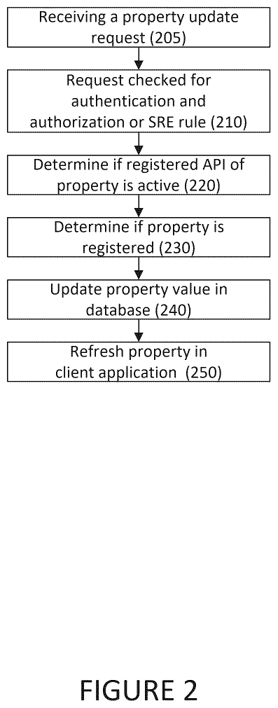

FIG. 2 is a method for dynamic configuration management, in accordance with some embodiments. The method may be stored as a list of instructions stored on a memory that when executed by one or more processors cause the one or more processors to perform the method.

Step 205 may include receiving, through an application configuration manager, a property update request. In some embodiments, the property update request may be initiated by a server providing an update to a particular application or type of application. In some embodiments, the property update request may be generated by an administrator in response to a security threat or an application change or improvement. The property update may be pushed to the application configuration manager through an API or an ingestion application. The property update may be a periodic update. The property update may be generated by the application configuration manager in response to a monitoring alert (e.g., changing an encryption) from a monitoring tool.

Step 210 may include checking, by the adaptive configuration manager, for authentication and authorization of the property update request or determining that a SRE rule is triggered.

Step 220 may include determining, by the adaptive configuration manager, if a registered API is active. Activity of the registered API may be determined by any state change in the registered API, which may be captured by the Adaptive Configuration Manager, ensuring states are maintained. States may be data that can change over time. States could be a button that may receive user input, a threshold monitor, a bandwidth capacity, a memory capacity, an operability status, or configuration settings. Activity of the registered API may be determined by a periodic check (e.g., weekly, monthly, annually) performed by invoking the API's endpoint.

Step 230 may include determining, by the adaptive configuration manager, if a property associated with the property update is registered. This may include checking a registration database such as a database stored on a memory accessible by the adaptive configuration manager. The database may be a permanent or temporary memory. The database may be a cloud-based memory. The database may be distributed over a number of computers of a network.

Step 240 may include updating, by the adaptive configuration manager, the property or one or more property values associated with the property.

The property or one or more property values may be updated including Feature Flags & Rollbacks including when deploying a new feature behind a feature flag, the adaptive configuration manager may enable or disable the new feature dynamically without restarting the application. For example, if an issue arises, the adaptive configuration manager may roll back instantly by turning off the feature flag via the configuration API, avoiding a redeployment.

The property or one or more property values may be updated including Dynamic Rate Limiting & Throttling that includes API rate limits being adjusted by the adaptive configuration manager in real-time based on traffic patterns. Additionally, if an API is experiencing high load, the adaptive configuration manager may reduce allowed requests per second dynamically to prevent service degradation.

The property or one or more property values may be updated including A/B Testing & Experimentation that includes dynamically enable different configurations by the adaptive configuration manager for different user segments without code changes. This allows easy A/B testing (e.g., two-sample hypothesis testing) by switching between feature versions or user interface (“UI”) variations on the fly.

The property or one or more property values may be updated including Database Connection & Timeout Adjustments that includes if a database starts experiencing slow queries or high latency, the adaptive configuration manager may increase the connection timeout dynamically instead of requiring a restart.

The property or one or more property values may be updated including Logging & Debugging Levels including by the adaptive configuration manager increasing logging verbosity for debugging issues in production without restarting the application. Once debugging is complete, logging can be reset dynamically by the adaptive configuration manager to reduce performance overhead.

The property or one or more property values may be updated including Third-Party API Keys & Configurations including by the adaptive configuration manager, if an external service changes an API key or endpoint, dynamically without redeploying applications. This is useful when rotating secrets or switching between multiple providers.

The property or one or more property values may be updated including Dynamically Updating Business Rules including by the adaptive configuration manager including applications with business rules (e.g., discount calculations, access policies, workflow thresholds) can be updated dynamically without modifying code or restarting services. This solution enhances flexibility, reduces downtime, and improves operational efficiency across various scenarios.

Step 250 may include refreshing, by the adaptive configuration manager, the property in the client application. The dynamic property refresh enables real-time configuration updates without restarting the application. Refresh may be accomplished by the adaptive configuration storing one or more or each property in a database and exposing the one or more or each property via the Adaptive Configuration Manager's API. In some embodiments, refresh may be accomplished by a custom-built library periodically fetching the latest properties from the API and updates a current environment (e.g., an environment on which the application is running, spring application runtime) dynamically. In some embodiments, refresh may be accomplished by a background scheduler ensuring properties are refreshed at fixed intervals, applying updates seamlessly across the application. This approach allows changes in feature flags, logging levels, and other configurations to take effect instantly, improving flexibility and operational efficiency.

If authentication and/or authorization is unsuccessful, if the registered API is inactive, and/or if the property is not registered, then the adaptive configuration manager may generate an alert to one or more administrators. Alternatively or additionally, if a registration token is invalid, the request will not go through because it may be placed on a prohibited list and any API calls using the registration token may be disabled.

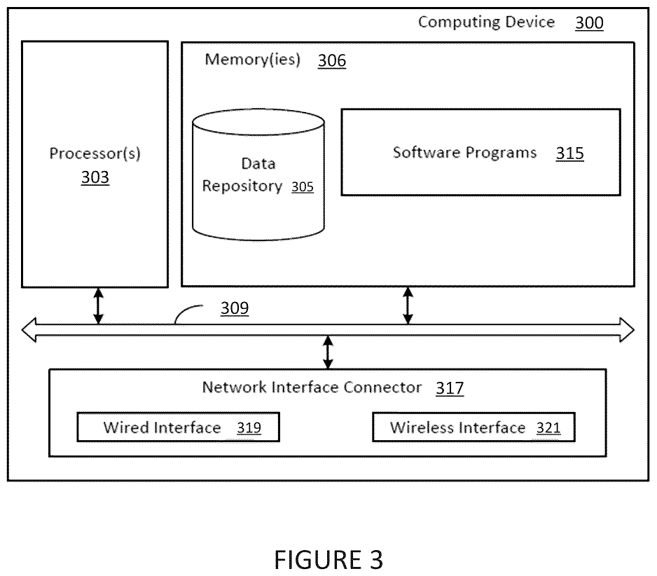

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, through an application configuration manager executed by one or more processors, a property update request for a property;
determining, by the adaptive configuration manager, authentication and authorization of the property update request;
determining, by the adaptive configuration manager, if a registered application programming interface (“API”) associated with the property is active;
determining, by the adaptive configuration manager through a call to an adaptive case management application operatively connected to a registration database, if the property associated with the property update is registered;
updating, by the adaptive configuration manager, a property value of the property in a property database operatively connected to the adaptive configuration manager; and
refreshing, by the adaptive configuration manager, the property in the client application.

2. The method of claim 1, wherein the property update request is initiated by a server providing an update to a type of application that includes the client application.

3. The method of claim 1, wherein the property update request is initiated by a server monitoring application determining that the property value of the client application exceeds a threshold.

4. The method of claim 1, wherein the determination that the registered API is active by a state change in the registered API captured by the adaptive configuration manager.

5. The method of claim 1, wherein the determination that the registered API is active by a periodic check performed by the adaptive configuration manager invoking the API's endpoint.

6. The method of claim 1, wherein the property value is a feature flag that the adaptive configuration manager updates without restarting the client application.

7. The method of claim 1, wherein the property value is an API rate limit adjusted by the adaptive configuration manager in real-time based on traffic patterns recorded by the client application that the adaptive configuration manager receives by determining a state of the client application.

8. The method of claim 6, wherein the adaptive configuration manager changes a threshold of the client application to reduce allowed requests per second.

9. The method of claim 1, wherein the property value is a configuration setting adjusted by the adaptive configuration manager for different user segments without code changes by switching between feature versions of the client application.

10. The method of claim 1, wherein the property value is a connection timeout that the adaptive configuration manager changes without a restart of the client application.

11. The method of claim 1, wherein the property value is an increase of a logging verbosity for debugging issues in production that the adaptive configuration manager changes without restarting the application.

12. The method of claim 1, wherein the property value is a third-party API key that the adaptive configuration manager updates if an external service changes the third-party API key or endpoint.

13. The method of claim 1, wherein the property value is a business rule that the adaptive configuration manager changes without modifying code or restarting services.

14. The method of claim 1, wherein refreshing occurs by the adaptive configuration storing one or more or each property in a database and exposing the property via the adaptive configuration manager's API.

15. The method of claim 1, wherein refreshing is accomplished by a custom-built library being periodically invoked by the adaptive configuration manager's API, wherein the adaptive configuration manager fetches an updated property from updating a current environment with the updated property.
